(19) United States
(12) Patent Application Publication
(10) Pub. No.: US 2024/0343409 A1
(43) Pub. Date: Oct. 17, 2024

(54) AIRCRAFT HAVING A DIHYDROGEN SUPPLY PIPE SEATED IN A CORRIDOR DELIMITED BETWEEN TWO SPARS OF A WING

(71) Applicant: Airbus Operations SAS, TOULOUSE (FR)

(72) Inventor: Mathieu BELLEVILLE, TOULOUSE (FR)

(21) Appl. No.: 18/632,361

(22) Filed: Apr. 11, 2024

(30) Foreign Application Priority Data
Apr. 14, 2023 (FR) 2303751

(51) Int. Cl. B64D 37/30; B64C 3/18; B64D 27/12

(52) U.S. Cl. CPC B64D 37/30; B64D 27/12; B64C 3/185

(57) ABSTRACT

An aircraft having a wing, a dihydrogen-powered engine, a supply pipe for the dihydrogen, in which each wing has a front spar, a first rear spar extending behind the front spar and a second rear spar extending behind the first rear spar, in which the two rear spars together define a corridor, and in which each supply pipe extends backwards from the related engine then into the corridor of the wing carrying the related engine.

### CROSS-REFERENCES TO RELATED APPLICATIONS

This application claims the benefit of French Patent Application Number 2303751 filed on Apr. 14, 2023, the entire disclosure of which is incorporated herein by way of reference.

### FIELD OF THE INVENTION

The present invention relates to the field of aircraft and, in particular, aircraft of which the energy source is liquid or gaseous dihydrogen for supplying a combustion chamber of an engine. The present invention also relates to an aircraft including a dihydrogen supply pipe seated in a corridor delimited between two spars of a wing of the aircraft.

### BACKGROUND OF THE INVENTION

It is known to use dihydrogen as energy source in certain vehicles. Dihydrogen could therefore be used as an energy source in an aircraft. The dihydrogen is stored in a tank and a supply pipe conveys the dihydrogen from the tank towards the combustion chamber of an engine.

FIG. 3 shows an aircraft 300 in the prior art that comprises a wing 302 on each side of a fuselage 303, with at least one dihydrogen-powered engine 304 fastened beneath each wing 302. The aircraft 300 has a dihydrogen tank 308 and a supply pipe 306 that conveys the dihydrogen to each engine 304 from the tank 308.

Each wing 302 has a front spar 301a and a rear spar 301b, as well as a lower-surface wall and an upper-surface wall fastened beneath and above the spars 301a-b. The movable elements of the wing 302, such as the ailerons and the actuators of these movable elements, are also fastened in an articulated manner to the rear spar 301b.

The engine 304 has a compressor and a turbine 305 upstream and downstream of the combustion chamber of the engine 304. In the event of damage to the engine 304, fragments, in particular fragments of blades of the compressor and/or of the turbine 305, may be separated from the rotating shaft to which they are fastened, resulting in a risk of collision with a supply pipe 306.

It is therefore desirable to provide an arrangement that ensures that the supply pipe is protected from any debris coming from the compressor and/or the turbine.

### SUMMARY OF THE INVENTION

An objective of the present invention is to propose an aircraft including a dihydrogen supply pipe seated in a corridor delimited between two spars of a wing of the aircraft.
To that end, an aircraft is proposed, having:
at least one wing,
a dihydrogen tank,
for each wing, at least one dihydrogen-powered engine fastened to the wing and having a rotor, and
for each engine, a supply pipe fluidically connected between the engine and the dihydrogen tank,
in which each wing has a front spar extending in a front part of the wing and a first rear spar extending behind the front spar and a second rear spar extending behind the first rear spar, in which the two rear spars together define a corridor, and
in which each supply pipe extends backwards from the related engine then into the corridor of the wing carrying the related engine.

This arrangement protects the supply pipe from any debris coming from the engine. In particular, since the first and second rear spars are not in the path of any debris coming from the engine, the supply pipe, being arranged in the corridor between said first and second rear spars, is also not in the path of any debris coming from the engine.

Advantageously, each wing has at least one bottom window in a lower-surface skin that opens the corridor through said lower-surface skin, and at least one top window in an upper-surface skin that opens the corridor through said upper-surface skin.

Advantageously, the top window is at a proximal end of the wing and the bottom window is at a distal end of the wing.

Advantageously, the top window is at a distal end of the wing and the bottom window is at a proximal end of the wing.

Advantageously, the aircraft includes, for each corridor, a fan arranged inside said corridor.

Advantageously, the aircraft includes a protective wall made of a thermally insulating material between the supply pipe and the second rear spar.

Advantageously, each of the front spars and of the first and second rear spars extend globally over the entire length of the wing.

Advantageously, the distance between the first rear spar and the second rear spar, between a leading edge and a trailing edge of the wing, is less than the distance between the first rear spar and the front spar.

### BRIEF DESCRIPTION OF THE DRAWINGS

The features of the invention mentioned above, along with others, will become more clearly apparent upon reading the following description of one exemplary embodiment, said description being given with reference to the appended drawings, in which:

FIG. 1 is a top view of an aircraft according to the invention,

FIG. 2 is a view in cross section of a wing of the aircraft in FIG. 1 along the line II-II, and

FIG. 3 is a top view of an aircraft in the prior art.

### DETAILED DESCRIPTION OF THE PREFERRED EMBODIMENTS

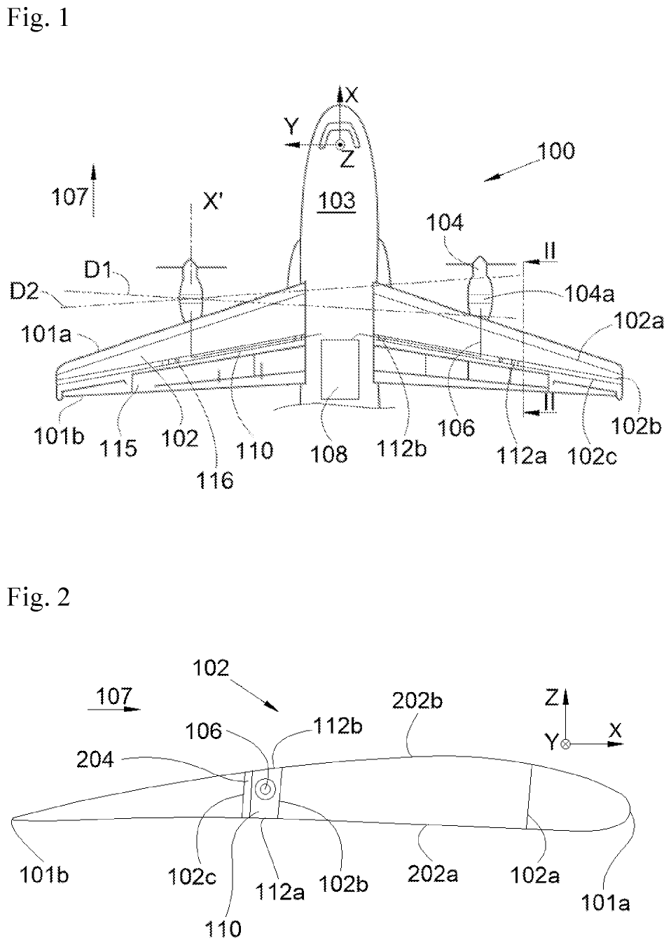

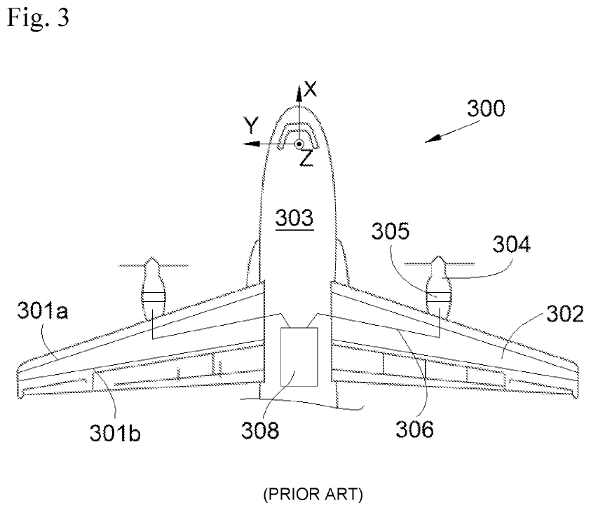

FIG. 1 shows an aircraft 100 that has a fuselage 103 on each side of which is fastened a wing 102 that conventionally has a leading edge 101a at the front and a trailing edge 101b at the rear. At least one engine 104 is fastened beneath each wing 102. In the embodiment of the invention shown in FIG. 1, each engine 104 is fastened at the leading edge 101a of the wing 102.

By convention, the direction X is the longitudinal direction of the aircraft 100, the direction Y is the transverse direction of the aircraft 100, which is horizontal when the aircraft is on the ground, and the direction Z is the vertical direction or vertical height when the aircraft is on the ground, these three directions X, Y and Z being mutually orthogonal.

Moreover, the terms “front” and “rear” are to be considered relative to a direction of forward movement of the aircraft 100 when the engines 104 are in operation, this direction being schematically shown by the arrow 107.

In the embodiment of the invention presented here, each engine 104 is a jet engine with a dihydrogen-fueled combustion chamber. The engine 104 also comprises at least one rotor 104a that is moveable in rotation about an axis of rotation X′ that is substantially parallel to the longitudinal direction X. “Substantially parallel” means that the axis of rotation X′ is parallel to the longitudinal direction X to within a few degrees, these degrees corresponding to normal tolerances present in the manufacture and installation of the rotor. By way of non-limiting example, the shaft of the rotor 104a may extend along an axis having an inclination in the plane XY of between −5° and +5° relative to the longitudinal direction X, and more specifically between −1° and +1° relative to the longitudinal direction X, and along an axis having an inclination in the plane XZ of between −10° and +10° relative to the longitudinal direction X, and more specifically between −5° and +5° relative to the longitudinal direction X. The rotor 104a may be a compressor and/or a turbine comprising blades fastened to a disk rotating about said axis of rotation X′.

Conventionally, the compressor and the turbine of the rotor 104a are upstream and downstream of the combustion chamber of the engine 104.

On account of the rotational movement of the rotor 104a of an engine 104, any debris coming from a blade or from a disk of said rotor 104a will statistically enter a volume delimited by two straight lines D1 and D2 that rotate about and intersect with the axis of rotation X′ of the engine 104, and in which each one forms an angle in relation to said axis of rotation X′.

The aircraft 100 also has a dihydrogen tank 108 that in this case is arranged in a central part of the fuselage 103, but that could be arranged in another part of the aircraft 100. The dihydrogen may be liquid or gaseous.

To convey the dihydrogen, the aircraft 100 has, for each engine 104, a supply pipe 106 fluidically connected between the engine 104 and the tank 108.

FIG. 2 shows a cross-section of the wing 102 that has a lower-surface wall 202a and an upper-surface wall 202b, with a front spar 102a extending therebetween along the wing 102 in the front part of the wing 102 just behind the leading edge 101a. The front spar 102a is generally arranged at a distance between 10% and 25% of the distance from the leading edge 101a to the trailing edge 101b (i.e., from the chord of the wing 102), from the leading edge 101a.

The wing 102 also has, between the lower-surface wall 202a and the upper-surface wall 202b, a first rear spar 102b extending behind the front spar 102a and a second rear spar 102c extending behind the first rear spar 102b. The first rear spar 102b is generally arranged at a distance between 50% and 70% of the distance between the leading edge 101a and the trailing edge 101b, from the leading edge 101a. The second rear spar 102c is generally arranged at a distance between 60% and 75% of the distance between the leading edge 101a and the trailing edge 101b, from the leading edge 101a. The distance between the first rear spar 102b and the second rear spar 102c is between 5% and 10% of the rope of the wing 102. The first rear spar 102b is thus closer to the second rear spar 102c than to the front spar 102a, in the direction from the leading edge 101a to the trailing edge 101b of the wing 102 (i.e., along the chord of the wing 102). The distance between the first rear spar 102b and the second rear spar 102c is at least five times less than the distance between the first rear spar 102b and the front spar 102a. The first rear spar 102b is therefore arranged in a dissymmetric manner (i.e. not central) between the front spar 102a and the second rear spar 102c. A box is thus defined between the front spar 102a and the first rear spar 102b, while a corridor is defined between the first and second rear spars 102b-c.

Each spar 102a-c extends globally in the transverse direction Y.

In other words, each spar 102a-c extends over the entire length of the wing 102 between the root of the wing 102 at fuselage 103 and the end of the wing 102 that is the furthest from fuselage 103 (corresponding to the tip of the wing 102).

The two rear spars 102b-c are globally parallel and together define a corridor 110 that therefore extends in the wing 102 between the two rear spars 102b-c and between the lower-surface wall 202a and the upper-surface wall 202b. The volume defined between the front spar 102a and the first rear spar 102b corresponds to a wing box, which represents a much larger volume (for example five times more) than the volume of corridor 110 defined between the two rear spars 102b-c. The corridor 110 is therefore distinct from a wing box.

Each spar 102a-c extends vertically between the lower-surface wall 202a and the upper-surface wall 202b.

As shown in FIG. 1, the rear spars 102b-c are arranged outside the volume corresponding to the debris field of a blade or a disk of said rotor 104a. These rear spars 102b-c are therefore advantageously protected, on account of the location thereof, from any such debris. In other words, these rear spars 102b-c are positioned such as to be unreachable by any debris from the engine 104.

Each supply pipe 106 extends backwards from the related engine 104, i.e., in this case globally from the leading edge 101a into the corridor 110 of the wing 102 carrying said engine 104. The supply pipe 106 therefore enters the corridor 110 as soon as possible to limit the portion of the supply pipe 106 that could be hit by debris.

The supply pipe 106 then extends inside the corridor 110, where it is protected, to the fuselage 103 and the tank 108.

The movable elements 115 of the wing 102, such as the ailerons and the actuators of these movable elements, are fastened in an articulated manner to the second rear spar 102c. According to the invention, the presence of the second spar 102c notably enables the fastening of the movable elements 115 of the wing 102, such installation not being possible on the first rear spar 102b on account of the presence of the supply pipe 106. Unlike in the prior art, in which the wing has a single rear spar to which the movable elements of the wing are fastened, the movable elements 115 of the wing 102 are in this case fastened to the second spar 102c.

With such an arrangement, very little of each supply pipe 106 is then outside a corridor 110 and, once inside a corridor 110, a supply pipe 106 is protected by the rear spars 102b-c, which are relatively solid structural elements that can deflect any debris. More specifically, the supply pipe 106, on account of the location thereof between the rear spars 102b-c, and notably behind the first rear spar 102b, is outside the volume corresponding to the debris field of a blade or a disk of said rotor 104a, and is therefore protected from potential impact of such debris. Furthermore, the supply pipe 106 benefits from additional protection against any debris outside the volume delimited between the straight lines D1 and D2, for example any debris from a turbine blade, by being behind the first rear spar 102b.

To ensure adequate ventilation of a corridor 110 and to prevent any accumulation of dihydrogen inside said corridor 110, each wing 102 has at least one bottom window 112a in the lower-surface skin 202a that opens the corridor 110 through said lower-surface skin 202a in order to communicate with the outside of the aircraft 100, and at least one top window 112b in the upper-surface skin 202b that opens the corridor 110 through said upper-surface skin 202b to communicate with the outside of the aircraft 100. The top window 112b and the bottom window 112a are for example NACA air inlets.

Therefore, an air current is created between said at least one top window 112b and said at least one bottom window 112a, which enables evacuation of the dihydrogen in the event of a leak from the supply pipe 106 in the corridor 110. More specifically, when the aircraft 100 is in flight, the pressure difference created by the wing 102 forces the outside air to pass through the corridor 110, entering via the bottom window 112a and exiting via the top window 112b.

Such a distribution enables the circulation of air in the corridor 110 to be guaranteed in-flight on account of the pressure difference between the lower surface and the upper surface of the wing 102.

To ensure the same air circulation on the ground, at least one fan 116 is installed in each corridor 110.

Conventionally, each wing 102 has a proximal end fastened to the fuselage 103 and a distal end at the opposite end.

In the embodiment of the invention shown in FIG. 1, there is a top window 112b at a proximal end of the wing 102 and a bottom window 112a at a distal end of the wing 102. Depending on the layout of the aircraft 100, the top window 112b could be at the distal end of the wing and the bottom window 112a could be at the proximal end of the wing. This is because, depending on the dihedral of the wing 102, the proximal or distal end respectively of the wing 102 is positioned higher (in the vertical direction Z) than the distal or proximal end respectively of the wing 102. For example, when the dihedral of the wing 102 is negative (i.e., the distal end is lower in the vertical direction Z than the proximal end), the top window 112b is arranged at the proximal end, while the bottom window 112a is arranged at the distal end. When the dihedral of the wing 102 is positive (i.e., the proximal end is lower in the vertical direction Z than the distal end), the bottom window 112a is arranged at the proximal end, while the top window 112b is arranged at the distal end.

The top window 112b and the bottom window 112a may be arranged in the same place on the wing 102, for example at the same distance from the plane YZ, which is the plane of symmetry of the aircraft 100. Preferably, the top window 112b and the bottom window 112a are arranged in different places on the wing 102, notably at different distances from the plane YZ.

The bottom window 112a may be arranged at the lowest point (in the vertical direction Z) of the wing (in flight), while the top window 112b may be arranged at the highest point of the wing 102. The top window 112b and the bottom window 112a are arranged to maximize the pressure difference between the air entering and exiting the corridor 110.

Where the second rear spar 102c carries the movable elements 115 of the wing 102 and the related actuators for these movable elements, it is desirable to ensure that dihydrogen leaks do not freeze these elements, given the cryogenic temperature of the dihydrogen. For this purpose, a protective wall 204 made of a thermally insulating material is arranged between the supply pipe 106 and the second rear spar 102c.

Such a thermally insulating material is, by way of non-limiting example, a closed-cell foam, or glass wool, or rock wool, or a product based on cork or glass microballs. The thermally insulating material may be a polyimide foam, or a silica fabric pressed and hardened at 65° C., or an expanded polystyrene core foam with a coating of metallized plastic, ceramic fiber based on alumina (Al₂O₃), silica (SiO₂) and boron trioxide (B₂O₃).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft having:
at least one wing,
a dihydrogen tank,
for each wing, at least one dihydrogen-powered engine fastened to the wing and having a rotor, and
for each dihydrogen-powered engine, a supply pipe fluidically connected between the dihydrogen-powered engine and the dihydrogen tank,
wherein each wing has a front spar extending in a front part of the wing and a first rear spar extending behind the front spar and a second rear spar extending behind the first rear spar, wherein the first and second rear spars together define a corridor, and
wherein each supply pipe extends backwards from the respective dihydrogen-powered engine into the corridor of the wing carrying the respective dihydrogen-powered engine.

2. The aircraft according to claim 1, wherein each wing has at least one bottom window in a lower-surface skin that opens the corridor through said lower-surface skin, and at least one top window in an upper-surface skin that opens the corridor through said upper-surface skin.

3. The aircraft according to claim 2, wherein the at least one top window is at a proximal end of the wing and wherein the at least one bottom window is at a distal end of the wing.

4. The aircraft according to claim 2, wherein the at least one top window is at a distal end of the wing and wherein the at least one bottom window is at a proximal end of the wing.

5. The aircraft according to claim 2, further comprising, for each corridor, a fan arranged inside said corridor.

6. The aircraft according to claim 1, wherein the aircraft further comprises:
a protective wall made of a thermally insulating material between the supply pipe and the second rear spar.

7. The aircraft according to claim 1, wherein each of the front spars and of the first and second rear spars extend globally over an entire length of the wing.

8. The aircraft according to claim 1, wherein a distance between the first rear spar and the second rear spar, and between a leading edge and a trailing edge of the wing, is less than a distance between the first rear spar and the front spar.
